(19) United States
(12) Patent Application Publication
(10) Pub. No.: US 2008/0034655 A1
(43) Pub. Date: Feb. 14, 2008

(54) Electrically Heated Plant Propagators

(76) Inventors: Janice Ryan, Cardiff (GB); Anthony Ryan, Cardiff (GB)

Correspondence Address: KING & SCHICKLI, PLLC, 247 NORTH BROADWAY, LEXINGTON, KY, 40507, US

(21) Appl. No.: 10/594,184

(22) PCT Filed: Mar. 23, 2005
(86) PCT No.: PCT/GB05/01174

§ 371 Date: May 4, 2007

(30) Foreign Application Priority Data
Mar. 23, 2004 (GB) 0406459.8

(51) Int. Cl. A01G 9/16

(52) U.S. Cl. 47/69

(57) ABSTRACT

According to the invention there is provided an electrically heated plant propagator (1, 9) comprising or including a transparent cover or lid (4, 10), characterised in that the cover or lid has electrically conductive heating elements (6) on or in the inner surface of the cover or lid, the heating elements being connectab a to an electric power supply by which the heating elements, through resistive heating, heat the inside of the plant propagator when the cover or lid is closed.

This invention relates to electrically heated plant propagators.

It is known to electrically heat plant propagators by providing under soil heating elements which keep the soil at a required temperature and which, in turn, keeps the air within the propagator also at an elevated temperature relative to the ambient temperature of the propagator's surroundings. In this way seeds can be induced to germinate before they would ordinarily do so and the growth of seedlings may subsequently be accelerated within the protection afforded by the usually transparent cover or lid.

A problem with such known plant propagators is that they are prone to induce condensation therewithin which may damage delicate plants and seedlings, cause e.g. mildew to build up, as well as reduce the transmission of light into the propagator, thereby reducing the amount of incoming ultraviolet radiation required in order for photosynthesis to take place. A further problem is that such under soil heating may provide local hotspots which could damage the roots of a plant and/or may dry out parts of the soil, thereby impeding the growth of roots.

The present invention is derived from the surprising realisation that the problem of the prior art may be obviated by heating the propagator in a different way which mimics the way in which vehicle windscreens are heated.

According to the invention there is provided an electrically heated plant propagator comprising or including a transparent cover or lid, characterised in that the cover or lid has electrically conductive heating elements on or in the inner surface of the cover or lid, the heating elements being connectable to an electric power supply by which the heating elements, through resistive heating, heat the inside of the plant propagator when the cover or lid is closed.

Conveniently, the propagator includes a soil tray over which the transparent cover or lid may be placed.

Conveniently, a spacer collar is provided between the cover or lid and the upper rim of the soil tray, which collar is preferably transparent, and provides room for plants to grow upwards before entering the space afforded by the inside of the cover or lid. The spacer collar may be integral with the cover or lid, or it may be separate, or it may be integral with the tray.

The spacer collar may be integral with the cover or lid which is conveniently hinged thereto and electrically connectable therewith, such as by a 12 volt or 24 volt electricity supply via a battery or from the mains electricity supply via a transformer. Alternatively, the spacer collar is separate from the cover or lid and may be connectable therewith by e.g. a push or snap fit guide formations and, where present, the soil tray may also be similarly connectable to the spacer collar and/or the cover or lid.

Preferably, handle means are provided on respectively opposite sides of the cover or lid and/or the spacer, and/or the soil tray, which handle means may include guide or locking formations such as projections or recesses by which the respective parts may be releasably secured together.

Conveniently, a thermostat may be provided, such as on or in the spacer collar, to ensure that the chosen temperature is maintained.

The spacer collar itself may also be electrically heated through the use of electrically conductive heating elements and the tray itself, where present, may also be electrically heated through conventional means, either separately or through a single unified electric circuit.

Conveniently, a sensor may be incorporated into the propagator to sense conditions in which condensation may be induced, such as by a sharp drop in ambient temperature outside the propagator as compared to the air temperature within the propagator, a logic circuit then e.g. automatically switching the heating elements for the transparent cover or lid and/or the spacer collar on in order to prevent or inhibit the build up of condensation, the sensor also sensing when conditions have changed such that the heating circuit may be switched off when an appropriate rise in ambient temperature has been noted.

Conveniently, the handle means may include electrical contact means, such as a socket, for connecting the propagator to an electricity supply, and the handle means may also include switches, sensors and indicators such as electric lights for indicating the status of the propagator e.g. “off” or “on”, operating temperature, humidity inside the propagator, and so on.

The invention will now be described, by way of example only, with reference to the accompanying drawings in which:

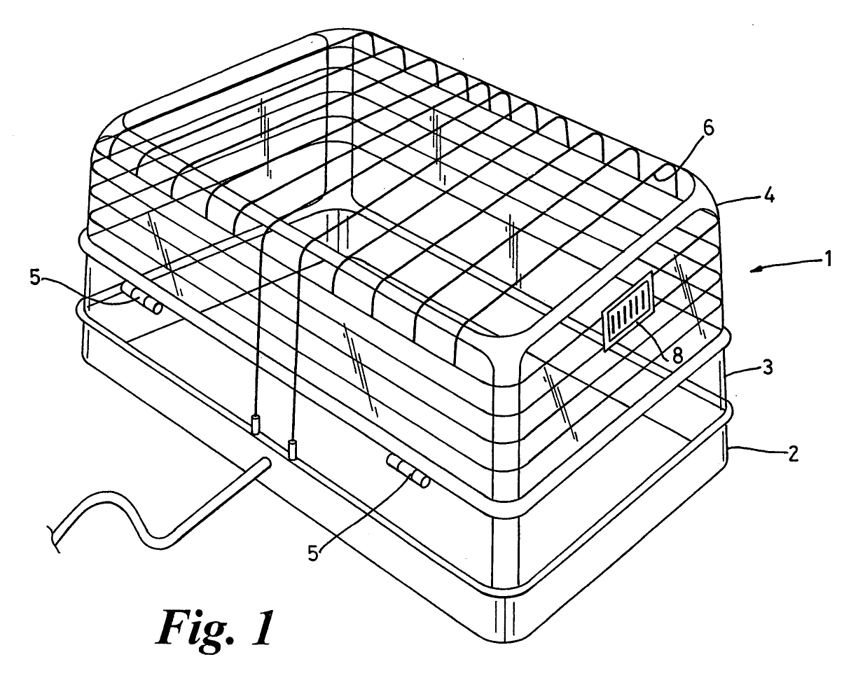

FIG. 1 is a perspective view of the rear of a plant propagator according to the invention,

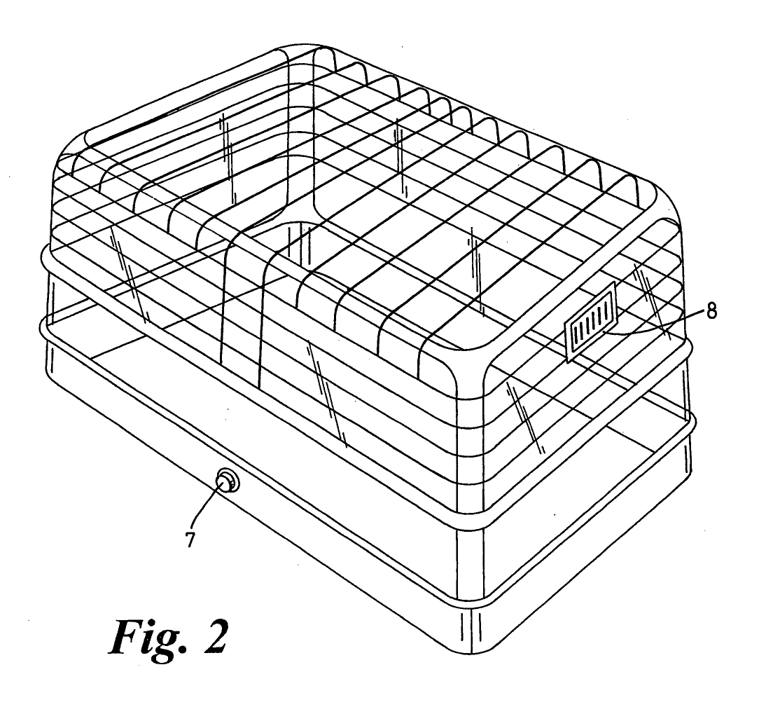

FIG. 2 is a perspective front view of the plant propagator of FIG. 1,

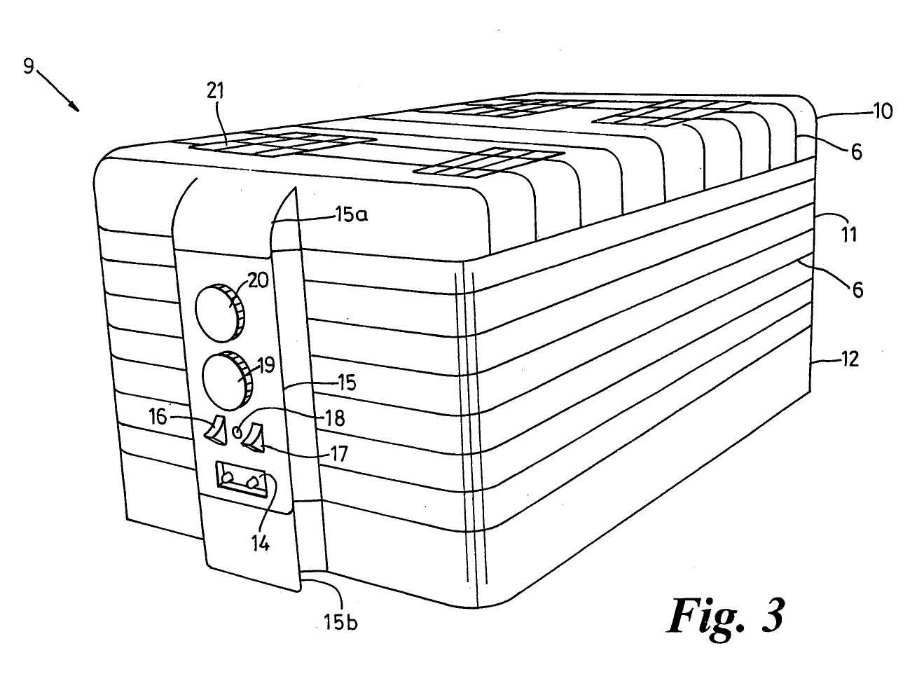

FIG. 3 is a perspective view of a second, preferred, embodiment of the invention in its assembled state, and

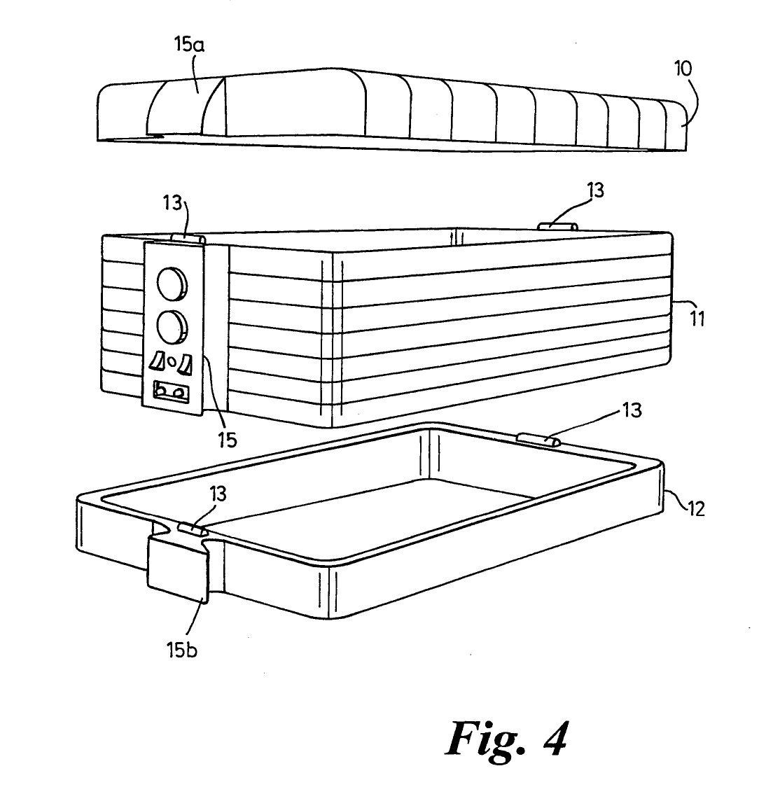

FIG. 4 is an exploded view of the embodiment of FIG. 3.

Referring first to FIG. 1 a plant propagator shown generally at 1 is in three part form, namely a soil tray 2 for containing soil, a transparent spacer collar 3 and a transparent cover or lid 4. The cover or lid 4 is joined to the collar 3 by a pair of hinges 5 and the collar itself is detachably secured to the outer rim of the tray 2 so as to allow the tray 2 to be filled with soil as required or for existing soil to be replaced.

On the inside surface of the cover or lid is an electrically conducting heating grid or element 6 which may be a single flat copper wire extending over all or part of the inside of the cover or lid 4. The heating element 6 is connected to a thermostat 7 (shown in FIG. 2) and a power inlet socket (not shown) by which it and the heating element 6 may be electrically activated. This may be by e.g. the insertion of a jackplug connected to a 12 or 24 volt battery (not shown) or where mains electricity is conveniently available a transformer (not shown) may be used to provide an electrical supply of a required voltage if other than mains voltage.

Although it is normally desirable to keep the inside of a propagator warm and moist nevertheless there are occasions when it is preferable to provide ventilation without opening the cover or lid and this is achieved via slidably openable vents 8 around the periphery of the spacer collar 3.

In use, because the heating element 6 is disposed on the inside surface of the cover or lid 4, when it is operating because there is an imbalance between the temperature therewithin and ambient temperature such that the former is higher than the latter, particularly at night, condensation cannot form or if forms it immediately evaporates, thereby avoiding the formation of large droplets of water which could block sunlight, drip onto e.g. seedlings or delicate plants or otherwise act in an undesirable manner of running down the sides of the propagator to wash into the soil in the tray 2 and thereafter evaporate therefrom in a manner illustrative of prior art electrically heated plant propagators.

As well as the thermostat 7, a separate sensor (not shown) may be incorporated within the propagator to sense e.g. a sharp decrease in ambient temperature as opposed to the air temperature within the propagator 1 and through the use of a logic circuit switch the heating element 6 on until the temperature in balance ends, such that if, say, the propagator 1 has conventional under soil heating in the tray 2 the use of the heating element 6 may be selectively employed in order to specifically prevent or inhibit the build up of condensation, or if a conventional heating element is not present in the tray 2 the heating element 6 may heat the soil and air within the propagator 1, thereby dispensing with separate heating for the soil itself.

Turning now to the preferred embodiment of invention shown with reference to FIGS. 3 and 4, a propagator shown generally at 9 includes a generally transparent cover or lid 10, a spacer collar 11 and a soil tray 12, releasably connectable to each other by a push or snap fit by means of guide/locking projections 13 (shown in FIG. 4) on respectively opposite upper ends of the collar 11 and soil tray 12 and being engageable within correspondingly shaped recesses (not shown) on the underside of the top or cover 10 and the collar 11.

As with the embodiment shown with reference to FIGS. 1 and 2, heating elements 6 are disposed on the inside surfaces of, respectively, the cover or lid 10 and the spacer collar 11 and are electrically connectable to a power input socket 14 within handle means 15 which extends continuously to an upper portion 15a of the cover or lid 10 and a lower portion 15b of the soil tray 12, a correspondingly shaped handle (not shown) being disposed on the opposite end of the propagator 9, thereby allowing the entire structure to be easily liftable by a pair of hands.

The handle means 15 on the side of the propagator 9 shown also includes switches 16, 17 for e.g. independently switching on or off the heating elements to the cover or lid 10 and the collar 11, or one of them may instead be used to switch on or off e.g. a heating grid or element (not shown) in the soil tray 12. A power indicator light 18 is also provided to indicate the state of the device e.g. on or off, and rotationally adjustable switches 19, 20 are provided for, respectively, temperature setting and temperature control although it will be understood that any suitable configuration may be adopted.

Vents 21 (shown in FIG. 3), which may be adjustable, are positioned at spaced intervals on top of the lid or cover 10 although it will be appreciated that they may be positioned elsewhere, such as in the sidewalls of the collar 11, or those of the soil tray 12.

In use, the propagator 9 may be used in the manner as shown with plants growing in soil contained in the soil tray 12, although it will be apparent that where the propagator 9 is to be used to protect existing plants the soil tray 12 may be dispensed with such that the propagator 9 is effectively used as an electrically heatable cloche. Similarly, although only one collar 11 is shown being used, any convenient number of collars may be used, some or all of which may be electrically connectable and heatable as required.

Although the heating elements 6 may be powered from a low voltage source corresponding to voltages typically used in vehicle batteries, nevertheless the invention may also utilise mains voltage, with the heating element 6 effectively being equivalent to e.g. heating elements used to heat electric blankets, the elements themselves being electrically insulated by e.g. plastic film or the like.

The invention, by borrowing technology from the automotive industry, therefore provides a neat and elegant solution to the prior art problems referred to above.

As will be evident to those skilled in the art, various modifications can be made or followed in light of the foregoing disclosure and discussion without departing from the spirit or scope of the invention.

1. An electrically heated plant propagator comprising or including a transparent cover or lid characterised in that the cover or lid has electrically conductive heating elements on or in the inner surface of the cover or lid, the heating elements being connectable to an electric power supply by which the heating element, through resistive heating, heats the inside of the plant propagator when the cover or lid is closed.

2. A propagator according to claim 1 further characterised in including a soil tray over which the transparent cover or lid may be placed.

3. A propagator according to claim 2 further characterised in including a spacer collar between the cover or lid and the upper rim of the tray.

4. A propagator according to claim 3 further characterised in that the spacer collar is transparent.

5. A propagator according to claim 3 further characterised in that the spacer collar is integral with the cover or lid.

6. A propagator according to claim 3 further characterised in that the spacer collar is separate from the cover or lid.

7. A propagator according to claim 3 further characterised in that the spacer collar, is integral with the tray.

8. A propagator according to claim 3 further characterised in that the spacer collar is separate from the cover or lid and is connectable therewith by push or snap fit guide formations.

9. A propagator according to claim 8 further characterised in that the soil tray is connectable to the spacer collar and/or the cover or lid by push or snap fit guide formations.

10. A propagator according to claim 3 further characterised in that handle means are provided on respectively opposite sides of the cover or lid and/or the spacer collar, and/or the soil tray.

11. A propagator according to claim 10 further characterised in that handle means includes guide or locking formations such as projections or recesses by which the respective parts can be releasably secured together.

12. A propagator according to claim 3 further characterised in that a thermostat is provided, such as on or in the spacer collar, to ensure that the chosen temperature is maintained.

13. A propagator according to claim 3 further characterised in that the spacer collar itself is electrically heated through the use of electrically conductive heating elements.

14. A propagator according to claim 3 further characterised in that the tray, where present, is also electrically heated.

15. A propagator according to claim 3 further characterised in that a sensor is incorporated into the propagator to sense conditions in which condensation may be induced.

16. A propagator according to claim 3 further characterised in that a logic circuit automatically switching the heating elements for the transparent cover or lid and/or the spacer collar on in order to prevent or inhibit the build up of condensation.

17. A propagator according to claim 15 further characterised in that the sensor also sensing when conditions have changed such that the heating circuit may be switched off when an appropriate rise in ambient temperature has been noted.

18. A propagator according to claim 10 further characterised in that the handle means includes electrical contact means, such as a socket, for connecting the propagator to an electricity supply.

19. A propagator according to claim 10 further characterised in that the handle means includes switches, sensors and indicators such as electric lights for indicating the status of the propagator “off” or “on”, operating temperature, humidity inside the propagator, and so on.

20. (canceled)

21. (canceled)

22. A propagator according to claim 11 further characterised in that the handle means includes electrical contact means, such as a socket, for connecting the propagator to an electricity supply.
